(19) United States
(12) Patent Application Publication
(10) Pub. No.: US 2025/0106723 A1
(43) Pub. Date: Mar. 27, 2025

(54) SWITCHING PERIOD INDICATION

(71) Applicant: Nokia Technologies Oy, Espoo (FI)

(72) Inventors: Lei DU, Beijing (CN); Johannes HEJSELBAEK, Aalborg (DK); Fahad SYED MUHAMMAD, Massy (FR)

(21) Appl. No.: 18/893,413

(22) Filed: Sep. 23, 2024

(30) Foreign Application Priority Data
Sep. 27, 2023 (WO) PCT/CN2023/122227

(51) Int. Cl. H04W 36/30; H04W 36/00; H04W 72/0453

(52) U.S. Cl. CPC H04W 36/304; H04W 36/008355; H04W 72/0453

(57) ABSTRACT

Embodiments of the present disclosure relate to devices, methods, apparatuses and computer readable storage media for switching period indication. The method comprising: at a first apparatus, determine a first switching period during which the first apparatus at least switches from a first frequency band to a second frequency band; determine that the first switching period is different from a second switching period indicated to a second apparatus for frequency band switching; based on determining that the first switching period is different from the second switching period, transmit, to the second apparatus, update information associated with the first switching period.

### FIELDS

Various example embodiments of the present disclosure generally relate to the field of telecommunication and in particular, to methods, devices, apparatuses and computer readable storage medium for switching period indication.

### BACKGROUND

In uplink (UL) Carrier Aggregation (CA) or supplementary uplink (SUL), user equipment (UE) is configured with more than one carrier. The UE may be also configured with UL transmission (Tx) switching and thus can have the UL transmission dynamically switched from one UL carrier to another UL carrier for enabling two transmission channel (2Tx) UL transmission on that carrier. If the UL carriers are located in different frequency bands (which may be also shorted as band), inter-band switching occurs.

### SUMMARY

In a first aspect of the present disclosure, there is provided a first apparatus. The first apparatus comprises at least one processor; and at least one memory storing instructions that, when executed by the at least one processor, cause the first apparatus to: determine a first switching period during which the first apparatus at least switches from a first frequency band to a second frequency band; determine that the first switching period is different from a second switching period indicated to the second apparatus for frequency band switching; based on determining that the first switching period is different from the second switching period, transmit, to the second apparatus, update information associated with the first switching period.

In a second aspect of the present disclosure, there is provided a second apparatus. The second apparatus comprises at least one processor; and at least one memory storing instructions that, when executed by the at least one processor, cause the second apparatus to: receive, from a first apparatus, update information associated with a first switching period during which the first apparatus at least switches from a first frequency band to a second frequency band, wherein the first switching period is different from a second switching period indicated by the first apparatus for frequency band switching; and determine, based on at least the update information, a starting time for scheduling data transmission between the first apparatus and the second apparatus.

In a third aspect of the present disclosure, there is provided a method. The method comprises: determining, at a first apparatus, a first switching period during which the first apparatus at least switches from a first frequency band to a second frequency band; determining that the first switching period is different from a second switching period indicated to the second apparatus for frequency band switching; based on determining that the first switching period is different from the second switching period, transmitting, to the second apparatus, update information associated with the first switching period.

In a fourth aspect of the present disclosure, there is provided a method. The method comprises: receiving, at a second apparatus from a first apparatus, update information associated with a first switching period during which the first apparatus at least switches from a first frequency band to a second frequency band, wherein the first switching period is different from a second switching period indicated by the first apparatus for frequency band switching; and determining, based on at least the update information, a starting time for scheduling data transmission between the first apparatus and the second apparatus.

In a fifth aspect of the present disclosure, there is provided a first apparatus. The first apparatus comprises means for determining a first switching period during which the first apparatus at least switches from a first frequency band to a second frequency band; means for determining that the first switching period is different from a second switching period indicated to the second apparatus for frequency band switching; means for based on determining that the first switching period is different from the second switching period, transmitting, to the second apparatus, update information associated with the first switching period.

In a sixth aspect of the present disclosure, there is provided a second apparatus. The second apparatus comprises means for receiving, from a first apparatus, update information associated with a first switching period during which the first apparatus at least switches from a first frequency band to a second frequency band, wherein the first switching period is different from a second switching period indicated by the first apparatus for frequency band switching; and means for determining, based on at least the update information, a starting time for scheduling data transmission between the first apparatus and the second apparatus.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates an example of a time mask for switching between two carriers;

FIG. 3 illustrates an example of a scheduled gap covering the switching period;

FIG. 4 illustrates a signaling chart for switching period indication according to some example embodiments of the present disclosure;

FIG. 5 illustrates a signaling chart for updating switching period according to some example embodiments of the present disclosure;

FIG. 6 illustrates a flowchart of a method implemented at a first device according to some example embodiments of the present disclosure;

FIG. 7 illustrates a flowchart of a method implemented at a second device according to some example embodiments of the present disclosure;

FIG. 8 illustrates a simplified block diagram of a device that is suitable for implementing example embodiments of the present disclosure; and

FIG. 9 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” . . . , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “switch-from carrier” may refer to a carrier from which a device (e.g., the UE) switches to further carrier, and the term “switch-to carrier” may refer to the further carrier to which the device switch from the carrier. Similarly, a band including the switch-from carrier may be referred to as “switch-from band” and a band including the switch-to carrier may be referred to as “switch-to band”.

### Example Environment

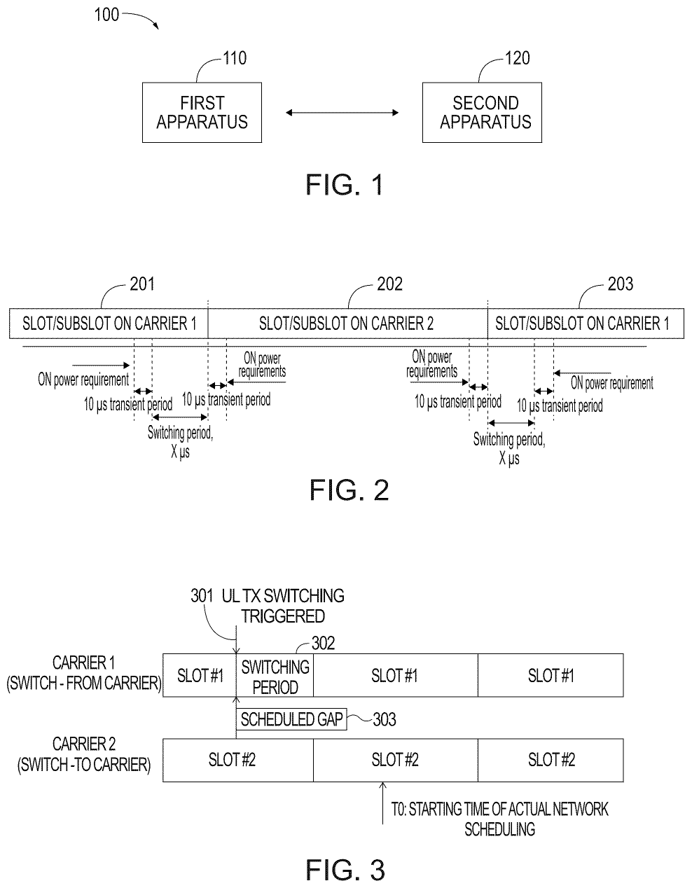

FIG. 1 illustrates an example communication environment 100 in which example embodiments of the present disclosure can be implemented. In the communication environment 100, a first apparatus 110 and a second apparatus 120 can communicate with each other. In some example embodiments, the first apparatus 110 may comprise a terminal device (for example, a UE), and the second apparatus 120 may comprise a network device (for example, a gNB).

It is to be understood that the number of second apparatus and first apparatus shown in FIG. 1 is given for the purpose of illustration without suggesting any limitations. The communication environment 100 may include any suitable number of second apparatus and first apparatus.

In the following, for the purpose of illustration, some example embodiments are described with the first apparatus 110 operating as a terminal device and the second apparatus 120 operating as a network device. However, in some example embodiments, operations described in connection with a terminal device may be implemented at a network device or other device, and operations described in connection with a network device may be implemented at a terminal device or other device.

In some example embodiments, if the first apparatus 110 is a terminal device and the second apparatus 120 is a network device, a link from the second apparatus 120 to the first apparatus 110 is referred to as a downlink (DL), and a link from the first apparatus 110 to the second apparatus 120 is referred to as an uplink (UL). In DL, the second apparatus 120 is a transmitting (Tx) device (or a transmitter) and the first apparatus 110 is a receiving (RX) device (or a receiver). In UL, the first apparatus 110 is a Tx device (or a transmitter) and the second apparatus 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Taking UE as an example, as mentioned above, in the uplink CA or SUL, a UE configured with uplink Tx switching can have Tx dynamically switched from one uplink carrier to another uplink carrier for enabling 2Tx UL transmission on that carrier. In Release 16 (R16), the switching between two carriers on two separate frequency bands is supported, where one of the two carriers supports 1Tx transmission and the other one supports 2Tx transmission in the uplink, which is multiple input multiple output (MIMO) transmission. In Release 17 (R17), the functionality was extended to support switching between two frequency bands, where one of the two bands can support two contiguous uplink carriers, and the switching takes place between the bands.

The multi-carrier enhancements for NR have been approved in Release 18 (R18). For example, for multi-carrier UL operation, there are some limitations of current technical specification. For example, 2Tx UE can be configured with at most 2 UL bands, which only can be changed by radio resource control (RRC) reconfiguration, and UL Tx switching can be only performed between 2 UL bands for 2Tx UE. Dynamically selecting carriers with UL Tx switching e.g., based on the data traffic, TDD DL/UL configuration, bandwidths and channel conditions of each band, instead of RRC-based cell(s) reconfiguration, may potentially lead to higher UL data rate, spectrum utilization and UL capacity. Table 1 shows the objectives of multi-carrier enhancements.

TABLE 1

| objectives | notes |
|---|---|
| UL Tx switching schemes | UE capability and RRC configuration |
| across up to 3 or 4 bands | related signalling (RAN2) |
| with restriction of up to | strive for RAN1/2 design agnostic with the |
| 2 Tx simultaneous | number of bands, i.e., common design |
| transmission for FR1 UEs, | between 3 and 4 bands |
| including mechanisms to | no additional TAG is introduced for UL |
| enable more configured | transmission on a carrier without |
| UL bands than its | corresponding DL carrier |
| simultaneous transmission | The number of TAGs is limited to up to 2. |
| capability and to support | this objective does not target to extend the |
| dynamic Tx carrier | SUL framework to support more than 1 |
| switching across the | SUL for 1 NUL |
| configured bands for both | |
| single TAG and multiple | |
| TAGs configurations | |
| (RAN1, RAN4) | |
| Switching time and other | Prioritize UL Tx switching across up to 3 |
| RF aspects, and RRM | bands is to be addressed first and then that |
| requirements for above | for up to 4 bands can also be addressed |
| UL Tx switching schemes | |
| across up to 3 or 4 bands | |
| (RAN4) | |

As can be seen from Table 1, one of the objectives of the multi-carrier enhancements is to study the UL switching scheme across 3 or 4 bands and define the Radio Resource Management (RRM) requirements. In R18, the UL Tx switching is further extended across 3 or 4 bands, where each Tx switching still occurs between 2 bands but the bands on which the UE is transmitting are dynamically selected from 3 or 4 configured bands so that at any given time at most two uplink transmitters are transmitting. That is, the UE could e.g., transmit uplink MIMO on any one of the 3 or 4 configured bands, while all other bands don't transmit, and then switch to transmit UL MIMO transmission on one other band out of the set of configured bands. Alternatively, the UE could transmit 1Tx transmission on one band and another 1Tx transmission on another band while other bands in the configuration are not used for uplink transmission.

The ambiguity issue of a switching period has been raised, e.g., when UL Tx switching is performed over two band pairs or in some fallback scenarios, and how to benefit network behavior to minimize the interruption. For example, when UE supports the two Tx switching band combinations of bands A+B+C+D and bands A+B+C+E, it is possible that UE has different switching periods for the same band pair.

FIG. 2 illustrates an example of a time mask for switching between two carriers. The UE may switch between UL carrier 1 and UL carrier 2, where the switching period is located in the slot/subslot during which the UL carrier 1 is used. As shown in FIG. 2, the UE may use a UL carrier 1 for UL transmission within a slot/subslot 201 and use a UL carrier 2 for UL transmission within a slot/subslot 202. This means that the UE switches from the UL carrier 1 to the UL carrier 2. Then, the UE uses the UL carrier 1 for UL transmission again within a slot/subslot 203. This means that the UE switches from the UL carrier 2 to the UL carrier 1. As shown in FIG. 2, switching periods are located at the end part of the slot/subslot 201 and the start part of the slot/subslot 203.

In some scenarios, when the UE receives the downlink control information (DCI) indication to perform dynamic switching between two UL carriers, the UE is allowed to cause DL interruption of X OFDM symbols in NR downlink carrier(s) as indicated by uplinkTxSwitching-DL-Interruption. The number of OFDM symbols being interrupted is determined considering the UL Tx switching periods which is indicated in the UE capability information as shown in Table 2 for example, as well as the transient periods specified in the time mask, for example as shown in FIG. 2.

TABLE 2

| | |
|---|---|
| ULTxSwitchingBandPair-r16 ::= | SEQUENCE { |
| bandIndexUL1-r16 | INTEGER(1..maxSimultaneousBands), |
| bandIndexUL2-r16 | INTEGER(1..maxSimultaneousBands), |
| uplinkTxSwitchingPeriod-r16 | ENUMERATED {n35us, n140us, n210us}, |
| uplinkTxSwitching-DL-Interruption-r16 | BIT STRING (SIZE(1..maxSimultaneousBands)) |
| OPTIONAL | |
| } | |
| ULTxSwitchingBandPair-v1700 ::= | SEQUENCE { |
| uplinkTxSwitchingPeriod2T2T-r17 | ENUMERATED {n35us, n140us, n210us} OPTIONAL |
| } | |

As shown in Table 2, only 3 values of the switching period are available for UE to report, i.e., 35 us, 140 us and 210 us.

In R18, when the UL Tx switching is extended between two uplink carriers across 3 or 4 bands, the switching pattern ambiguity issue was identified for parallel switching on four bands. The following agreements have been reached to address the issue by a band ordering based approach:

TABLE 3
RAN4 to agree on the band ordering based approach to resolve the
ambiguity issue for the parallel switching of two Tx chain in the case
{1T, 1T, 0T, 0T} to {0T, 0T, 1T, 1T} on bands {A, B, C, D}:
Associating the ordering of bands for defining switch-from and switch-to
pairs in switching configuration commands may resolve the ambiguity
issue without additional cost.
Introduce new per Tx chain-based Tx switching capability
Introduce optional UE capability on supporting the band ordering based
approach to resolve ambiguity issue

In Table 3, the agreement on the solutions to address the switching pattern ambiguity issue is shown. Some more agreements are reached, as shown in Table 4.

TABLE 4
From RAN4 UE implementation perspective, when UE support the two
Tx switching band combinations of band A + B + C + D and band A +
B + C + E, it is possible that UE has different switching periods for the
same band pair, for example:
For band A + B + C + D, A + B with period 35 us, A + C with period
140 us
For band A + B + C + E, A + B with period 210 us, A + C with period
35 us
In this case, RAN4 would like to ask RAN2 whether UE always report
the periods for band combination A + B + C.
If it is possible that UE does not additionally report the periods for band
combination A + B + C, RAN4 ask RAN2 how the length of switching
period for A + B and A + C are applied when the network configures
band combination A + B + C for Tx switching.

In any case, the ambiguity comes from different UE implementations when performing Tx switching between two band pairs. Although the above new UE capability in band-ordering based approach helps informing the network of the supported switching patterns per Tx-chain, the network still does not know which switching period length applies at each Tx switching. It is proposed to have UE reporting the switching period to be applied to the network.

In addition, there would also be the ambiguity issue of switching period if the switching period in use is different from the switching period indicated in UE capability information. This is likely because only 3 candidate values are available in the UE capability information. However, some UEs might implement the switching much faster than the value indicated to the network.

Meanwhile, RANI has been discussing how to handle the network scheduling over switching period. It was agreed that network may schedule a gap to absorb all, or at least some, of the switching period. If a long enough gap is scheduled to cover the switching period, the UE is not expected to be scheduled during the switching period. Hence, there is no impact on the transmission/reception on the carriers. Otherwise, if the gap only partially covers the switching period, the network may start scheduling the UE on the switch-to carrier before the end of the switching period. Hence, the scheduled symbols may be impacted. In the following, the starting time of network scheduling is represented by TO.

FIG. 3 illustrates an example of a scheduled gap covering the switching period. The carrier 1 is the switch-from carrier and the carrier 2 is the switch-to carrier. A UL Tx switching is triggered at the time 301. The network may start actual scheduling of the UE at the time T0. In the example, a switching period 302 is covered by a scheduled gap 303. The scheduled gap 303 is up to network implementation based on the switching period indicated in the UE capability information, where only 3 values {35 us, 140 us, 210 us} are available. However, if the UL Tx switching in practice or in use is completed earlier than what the network expected, the T0 determined based on the UE capability information may be too late, which unnecessarily delays the data resumption on the switch-to carriers and can degrade the system efficiency. On the other hand, if the UL Tx switching in practice is longer than what the network expected, the determined T0 may not cover the switching period, which hence brings impact or interruption to the data transmission on the carriers.

In general, to allow the UL Tx switching between multiple frequency bands and/or Tx chains within the UE, it has been agreed that the network should provide a sufficient gap in the scheduled transmissions for the UE to perform needed reconfigurations. The switching period needed have been discussed, but a solution to provide the network with needed information to ensure a “sufficient” gab is still needed.

To this end, the present disclosure proposes a solution for switching period indication. The solution is to rely on the UE information on the expected switching period, as the needed time may differ significantly dependent on which frequency band and/or Tx chain used for the switching which are dependent on the specific hardware implementation of the UE.

### Work Principle and Example Signaling for Communication

According to some example embodiments of the present disclosure, there is provided a solution for switching period indication for UL switching. In this solution, the first apparatus may determine a first switching period (e.g., switching period in use) during which the first apparatus at least switches from a first frequency band to a second frequency band. The first apparatus may determine that the first switching period is different from a second switching period indicated to the second apparatus for frequency band switching. Further, the first apparatus may transmit update information associated with the first switching period to the second apparatus. Such transmission of the update information may be based on determining that the first switching period is different from the second switching period.

In this way, the first apparatus (for example, UE) informs the second apparatus (for example, the network) of the updated switching period information of the switching period. The network is allowed to understand the switching period in use and determine the starting time of network scheduling in the best way. The system efficiency is improved by enabling scheduling as early as possible without impacting the data transmission.

Example embodiments of the present disclosure will be described in detail below with reference to the accompanying drawings.

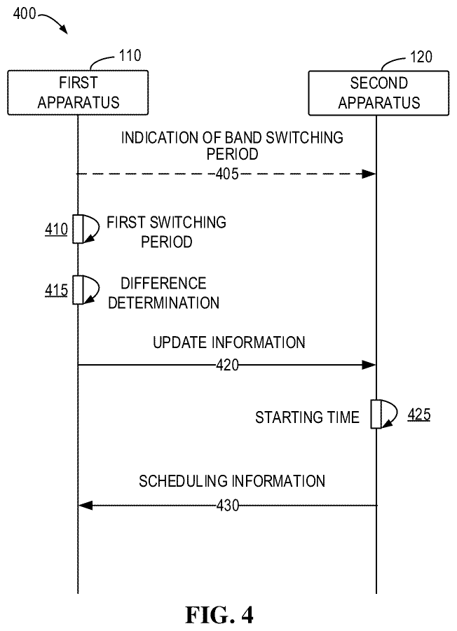

Reference is now made to FIG. 4, which illustrates a signaling chart for switching period indication according to some example embodiments of the present disclosure. As shown in FIG. 4, the signaling chart 400 involves the first apparatus 110 and the second apparatus 120. For the purpose of discussion, reference is made to FIG. 1 to describe the signaling chart 400. Although a single first apparatus 110 is illustrated in FIG. 4, it would be appreciated that there may be a plurality of first apparatuses performing similar operations as described with respect to the first apparatus 110 below. In some example embodiments, the first apparatus 110 may be a terminal device, for example, a UE and the second apparatus 120 may be a network device, for example, a gNB. In the following, some example embodiments are described with respect to the UE and the network. However, it is merely for purpose of discussion without any limitation.

As shown in FIG. 4, the first apparatus 110 may determine (410) a first switching period. During the first switching period, the first apparatus 110 may at least switch from a first frequency band to a second frequency band. For example, the first switching period may be a time period used to or to be used to switch from the first frequency band to the second frequency band, and thus may be referred to as switching period in use.

In some example embodiments, the switching may be triggered by an indication from the second apparatus 120, for example by DCI. In some example embodiments, the switching may be triggered autonomously by the first apparatus 110, for example, based on some conditions. Protection scope of the present disclosure is not limited in the trigger of the switching.

The first apparatus 110 may determine (415) whether the first switching period is different from a second switching period. The second switching period may be indicated to the second apparatus 120 for frequency band switching. For example, the second switching period may be indicated to the second apparatus 120 as a period for switching from the first frequency band to the second frequency band. In the following, the second switching period may be referred to as an indicated switching period or a reported switching period.

In some example embodiments, as shown in FIG. 4, the first apparatus 110 may transmit (405) an indication of the second switching period to the second apparatus 120. In some example embodiments, the second switching period may be indicated to the second apparatus 120 in capability information of the first apparatus 110. For example, if the first apparatus 110 is a UE, the first apparatus 110 may transmit the UE capability information including the second switching period to the second apparatus 120. Based on the indicated switching period, the second apparatus 120 may determine a starting time for scheduling the data transmission between the first apparatus 110 and the second apparatus 120. The starting time T0 determined based on the indicated switching period is also referred to as an original starting time.

Further, if the first apparatus 110 determines that the first witching period is different from a second switching period, the first apparatus 110 may transmit (420) update information associated with the first switching period to the second apparatus 120. The update information may be used to indicate the second apparatus 120 of the update of the switching period, and may be also referred to as updated switching period information.

In some example embodiments, the update information may be transmitted within a time period after trigger of the switching from the first frequency band to the second frequency band. For example, the UE shall send the update information within a certain time period after the UL Tx switching is triggered. For example, a certain time period may be defined to set a maximum delay requirement for the switching period information. If the first apparatus 110 does not send the updated switching period information within the time period, it shall not send any updates afterward and the second apparatus 120 would assume the switching period in the capability information would apply.

The time period may be defined based on the capability of the first apparatus 110, especially the maximum switching period possibly applied to the switching, and the start of network scheduling, i.e., TO. In some example embodiments, the time period may precede the original starting time for the second apparatus 120 to schedule the data transmission. As mentioned above, the original starting time is based on the second switching period. In other words, the first apparatus 110 shall report the updated switching period information before the second apparatus 120 resumes the data transmission scheduling.

The update information may include any suitable indication or information to indicate the update of the switching period. In some example embodiments, the update information may comprise the first switching period, for example, the switching period in use. Alternatively, or in addition, the update information may comprise a difference between the first and second switching periods, for example, a delta length between the switching period in use and the indicated switching period.

Alternatively, or in addition, the update information may comprise an indication of an end of the first switching period. That is, the first apparatus 110 may indicate the end of the switching when the switching is completed before the switching period as reported in the capability information. In this case, upon completion of the switching from the first frequency band to the second frequency band, the first apparatus 110 may transmit the indication of the end to the second apparatus 120.

In some example embodiments, the first apparatus 110 may transmit the update information to the second apparatus 120 on a first carrier in the first frequency band before switching to the second frequency band. For example, the transmission of the update information may occur before actually performing UL switching on the switch-from carrier. Alternatively, or additionally, in some example embodiments, the first apparatus 110 may transmit the update information to the second apparatus 120 on a second carrier in the second frequency band after switching to the second frequency band. For example, the transmission of the update information may occur after performing UL switching on the switch-to carrier.

In some example embodiments, whether to transmit the update information on the switch-from carrier or the switch-to carrier may be configured by the second apparatus 120. For example, the first apparatus 110 may receive a configuration from the second apparatus 120. The configuration may indicate whether to transmit the update information before the switching or after the switching. Alternatively, the configuration may indicate to transmit the update information on a carrier of a specific band of the two bands. For example, if the switching is between band A and band B, the configuration may indicate to transmit the update information on band A regardless of the switching direction. That is, the second apparatus 120 may configure where/when the first apparatus 110 reports the update information.

In some example embodiments, whether to transmit the update information on the switch-from carrier or the switch-to carrier may be indicated by the first apparatus 110 to the second apparatus 120. For example, the first apparatus 110 may determine whether the update information is to be transmitted before the switching or after the switching and transmit a corresponding indication to the second apparatus 120. That is, the first apparatus 110 may inform the second apparatus 120 where/when it will report the update information. For example, such an indication may be included in the capability information of the first apparatus 110.

Continue to refer to FIG. 2, the second apparatus 120 may receive the update information from the second apparatus 120 and may determine (425) a starting time for scheduling the data transmission between the first apparatus 110 and the second apparatus 120 based on at least the update information. The starting time may indicate the start of network scheduling, e.g., the T0 shown in FIG. 3. For example, the original starting time may be adjusted based on the update information. It is to be understood that depending on the difference between the switching period in use and the indicated switching period, the adjusted starting time may be before or after the original starting time.

Then, the second apparatus 120 may schedule the data transmission between the first apparatus 110 and the second apparatus 110 at the determined starting time T0. That is, the first apparatus 110 may receive (430) scheduling information for the data transmission from the second apparatus 120 at the starting time.

As described above, the first apparatus 110 may send updated switching period information after UL switching is triggered, but before the start of network scheduling. When the UE sends the switching period information, the interruption length is also determined based on the updated switching period. When the second apparatus 120 receives the switching period information on the switching period, the second apparatus 120 may determine or adjust the starting time of network scheduling (i.e., T0) accordingly. In the best case, T0 shall be determined to cover the switching period to avoid impact on data transmission. If the first apparatus 110 does not send the switching period information within the time period, the second apparatus 120 may assume that the switching period in the capability information of the first apparatus 110 would apply.

The switching from the first frequency band to the second frequency band is described above. In some example embodiments, the first apparatus 110 may further switch from a third frequency band to a fourth frequency band. In other words, switching between two band pairs may occur.

In some example embodiments, reporting of the updated switching period information may be performed in combination of the switching between the two band pairs. In this case, the first apparatus 110 may determine the first switching period based on a switching period applied to the switching from the first frequency band to the second frequency band and a switching period applied to the switching from the third frequency band to the fourth frequency band.

For example, the UL Tx switching may occur across 3 or 4 bands. One switching period (for example, the maximum one) may cover both the switching from the first frequency band to the second frequency band and the switching from the third frequency band to the fourth frequency band. Thus, the first time period is determined based on both the switching periods. In this way, the second apparatus 120 may schedule transmissions based on the longer switching period.

Alternatively, in some example embodiments, reporting of the updated switching period information may be performed separately for the two band pairs. For example, the process described above with reference to the band pair of the first and second frequency bands may be applied to the band pair of the third and fourth frequency bands. Specifically, the first apparatus 110 may determine a third switching period during which the first apparatus 110 switches from the third frequency band to the fourth frequency band. The first apparatus 110 may determine that the third switching period is different from a fourth switching period indicated to the second apparatus for the third and fourth frequency bands. Further, based on such difference determination, the first apparatus 110 may transmit further update information associated with the third switching period to the second apparatus 120.

For example, the switching from the first frequency band to the second frequency band and the switching from the third frequency band to the fourth frequency band are handled separately. Thus, further update information is reported to the second apparatus 120 if there is difference. In such example embodiments, if switching between a band pair is completed earlier, the network can resume scheduling on the switch-to carrier of that band pair earlier.

### An Example Process

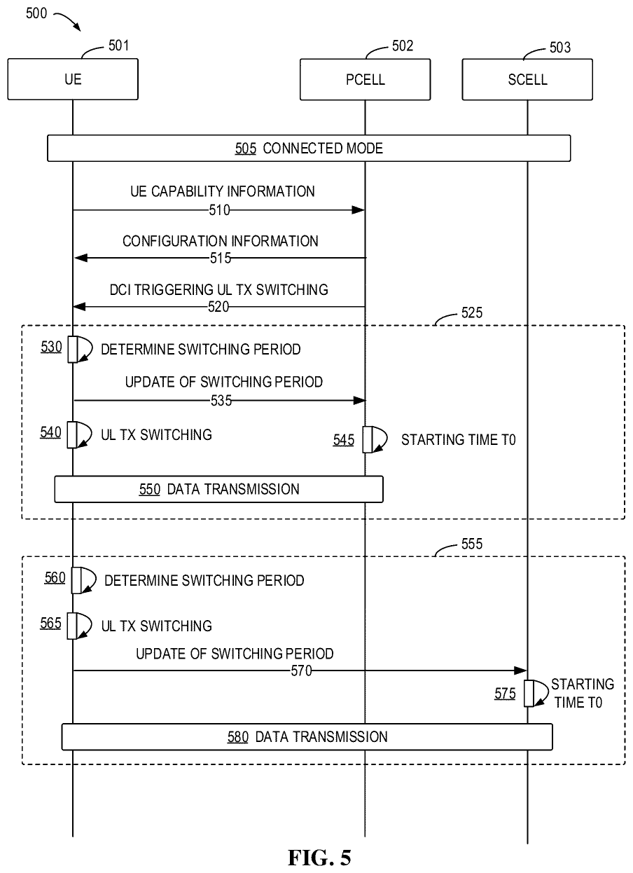

Reference is now made to FIG. 5, which illustrates a signaling chart 500 for update of switching period according to some example embodiments of the present disclosure. As shown in FIG. 5, the signaling chart 500 involves a UE 501, a primary cell (PCell) 502, and a secondary cell (SCell) 503. The chart 500 may be considered as an example of the chart 400 and the UE 501 may be considered as an example of the first apparatus.

The PCell 502 and the SCell 503 may be provided by the network. The PCell 502 may be associated with a carrier in the switch-from band and the SCell 503 may be associated with the other carrier in the switch-to band. It should be understood that the signaling chart 500 is illustrated using the UL Tx switching between two bands as example, the same behaviour may be applied if the UL Tx switching occurs across 3 or 4 bands.

As shown in FIG. 5, the UE 501 enters (505) into a connected mode, e.g., RRC connected mode, with the network. In the connected mode, the UE 501 may be configured with UL carriers on different bands by the network. The UE 501 may send (510) UE capability information to the network via the PCell 502, and the UE capability information may include UplinkTxSwitchingPeriod information, which indicates the switching period (the second switching period described above) to the network. Then, the UE 501 may receive (515) the corresponding configuration information from the network via the PCell 502. For example, the network may configure the UL Tx switching to the UE 501 by using RRC Reconfiguration message. The UE 501 may further receive (520) DCI triggering UL Tx switching from the network. The DCI triggers UL Tx switching between two bands (which may be referred to as a band pair) corresponding to the PCell 502 and the SCell 503.

In some example embodiments, an option 525 is performed. The UE 501 may determine (530) the switching period for the band pair and a delta between the two bands which is required to adjust the starting time of actual network scheduling, i.e., TO. The UE 501 may transmit (535) update of the switching period (for example, the delta) to the network via the PCell 502. For example, the UE 501 may report the delta to the network if the delta is non-zero. The UE 501 may perform (540) a UL Tx switching. In other words, the UL Tx switching occurs from the switch-from carrier to the switch-to carrier. Correspondingly, the network may adjust (545) the starting time T0 using the delta reported by the UE 501. Then, scheduling of the data transmission (550) between the UE 501 and the network starts at the adjusted starting time T0.

In some example embodiments, an option 555 is performed. The UE 501 may determine (560) the switching period for the band pair and the delta between the two bands which required to adjust the starting time T0. The UE 501 may perform (565) the UL Tx switching. In other words, the UL Tx switching occurs from the switch-from carrier to the switch-to carrier. The UE 501 may transmit (570) update of the switching period to the network via the SCell 503. For example, the UE 501 may report the delta to the network if the delta is non-zero. The network may adjust (575) the starting time T0 using the delta reported by the UE 501. Then, scheduling of the data transmission (580) between the UE 501 and the network starts at the adjusted starting time T0.

Last but not the least, the example embodiments of the present disclosure may allow the network to understand the switching period in use and determine T0 in the best way. In this way, communication system efficiency is improved by enabling scheduling as early as possible without impacting the data transmission.

### Example Methods

FIG. 6 shows a flowchart of an example method 600 implemented at a first device in accordance with some example embodiments of the present disclosure. For the purpose of discussion, the method 600 will be described from the perspective of the first apparatus 110 in FIG. 1.

At block 610, the first apparatus 110 determines a first switching period during which the first apparatus at least switches from a first frequency band to a second frequency band.

At block 620, the first apparatus 110 determines that the first switching period is different from a second switching period indicated to the second apparatus for frequency band switching.

At block 630, based on determining that the first switching period is different from the second switching period, the first apparatus 110 transmits, to the second apparatus, update information associated with the first switching period.

In some example embodiments, the method 600 further comprises: receiving, from the second apparatus at a starting time determined based on the update information, scheduling information for data transmission between the first apparatus and the second apparatus.

In some example embodiments, the update information is transmitted within a time period after trigger of the switching from the first frequency band to the second frequency band.

In some example embodiments, the time period precedes a further starting time for the second apparatus to schedule data transmission between the first apparatus and the second apparatus, and the further starting time is based on the second switching period.

In some example embodiments, the update information comprises at least one of: the first switching period, a difference between the first and second switching periods, or an indication of an end of the first switching period.

In some example embodiments, the method 600 further comprises: transmitting the update information to the second apparatus on a first carrier in the first frequency band before switching to the second frequency band, or transmitting the update information to the second apparatus on a second carrier in the second frequency band after switching to the second frequency band.

In some example embodiments, the method 600 further comprises: receiving, from the second apparatus, a configuration indicating whether to transmit the update information before the switching or after the switching.

In some example embodiments, the method 600 further comprises: transmitting, to the second apparatus, an indication whether the update information is to be transmitted before the switching or after the switching.

In some example embodiments, the second switching period is indicated to the second apparatus in capability information of the first apparatus.

In some example embodiments, switching from a third frequency band to a fourth frequency band is further triggered, and the method 600 further comprises: determining the first switching period based on a switching period applied to the switching from the first frequency band to the second frequency band and a switching period applied to the switching from the third frequency band to the fourth frequency band.

In some example embodiments, switching from a third frequency band to a fourth frequency band is further triggered, and the method 600 further comprises: determining a third switching period during which the first apparatus switches from the third frequency band to the fourth frequency band; determining that the third switching period is different from a fourth switching period indicated to the second apparatus for the third and fourth frequency bands; and based on determining that the third switching period is different from the fourth switching period, transmitting, to the second apparatus, further update information associated with the third switching period.

In some example embodiments, the first apparatus comprises a terminal device, and the second apparatus comprises a network device.

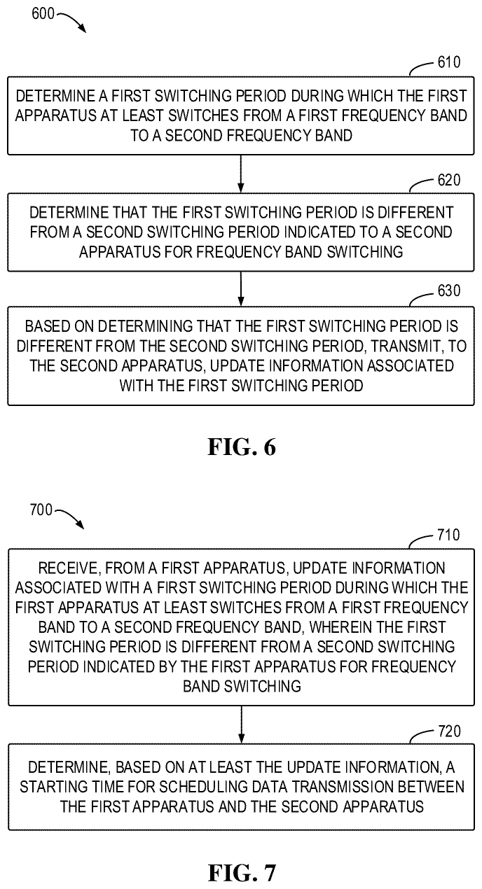

FIG. 7 shows a flowchart of an example method 700 implemented at a second device in accordance with some example embodiments of the present disclosure. For the purpose of discussion, the method 700 will be described from the perspective of the second apparatus 120 in FIG. 1.

At block 710, the second apparatus 120 receives, from a first apparatus, update information associated with a first switching period during which the first apparatus at least switches from a first frequency band to a second frequency band, wherein the first switching period is different from a second switching period indicated by the first apparatus for frequency band switching.

At block 720, the second apparatus 120 determines, based on at least the update information, a starting time for scheduling data transmission between the first apparatus and the second apparatus.

In some example embodiments, the method 700 further comprises: transmitting, to the first apparatus at the starting time, scheduling information for the data transmission between the first apparatus and the second apparatus.

In some example embodiments, the update information is received within a time period after trigger of the switching from the first frequency band to the second frequency band.

In some example embodiments, the time period precedes a further starting time for the second apparatus to schedule the data transmission between the first apparatus and the second apparatus, and the further starting time is based on the second switching period.

In some example embodiments, the update information comprises at least one of: the first switching period, a difference between the first and second switching periods, or an indication of an end of the first switching period.

In some example embodiments, the method 700 further comprises: receiving the update information from the first apparatus on a first carrier in the first frequency band before switching to the second frequency band, or receiving the update information from the first apparatus on a second carrier in the second frequency band after switching to the second frequency band.

In some example embodiments, the method 700 further comprises: transmitting, to the first apparatus, a configuration indicating whether to transmit the update information before the switching or after the switching.

In some example embodiments, the method 700 further comprises: receiving, from the first apparatus, an indication whether the update information is to be transmitted before the switching or after the switching.

In some example embodiments, the second switching period is indicated to the second apparatus in capability information of the first apparatus.

In some example embodiments, switching from a third frequency band to a fourth frequency band is further trigger for the first apparatus, and the method 700 further comprises: receiving, from the first apparatus, further update information associated with a third switching period during which the first apparatus switches from a third frequency band to a fourth frequency band, wherein the third switching period is different from a fourth switching period indicated by the first apparatus for the third and fourth frequency bands; and determining the starting time based on the update information and the further update information.

In some example embodiments, the first apparatus comprises a terminal device, and the second apparatus comprises a network device.

### Example Apparatus, Device and Medium

In some example embodiments, a first apparatus capable of performing any of the method 600 (for example, the first apparatus 110 in FIG. 1) may comprise means for performing the respective operations of the method 600. The means may be implemented in any suitable form. For example, the means may be implemented in a circuitry or software module. The first apparatus may be implemented as or included in the first apparatus 110 in FIG. 1.

In some example embodiments, the first apparatus comprises means for determining a first switching period during which the first apparatus at least switches from a first frequency band to a second frequency band; means for determining that the first switching period is different from a second switching period indicated to the second apparatus for frequency band switching; means for based on determining that the first switching period is different from the second switching period, transmitting, to the second apparatus, update information associated with the first switching period.

In some example embodiments, the first apparatus further comprises: means for receiving, from the second apparatus at a starting time determined based on the update information, scheduling information for data transmission between the first apparatus and the second apparatus.

In some example embodiments, the update information is transmitted within a time period after trigger of the switching from the first frequency band to the second frequency band.

In some example embodiments, the time period precedes a further starting time for the second apparatus to schedule data transmission between the first apparatus and the second apparatus, and the further starting time is based on the second switching period.

In some example embodiments, the update information comprises at least one of: the first switching period, a difference between the first and second switching periods, or an indication of an end of the first switching period.

In some example embodiments, the first apparatus further comprises: means for transmitting the update information to the second apparatus on a first carrier in the first frequency band before switching to the second frequency band, or means for transmitting the update information to the second apparatus on a second carrier in the second frequency band after switching to the second frequency band.

In some example embodiments, the first apparatus further comprises: means for receiving, from the second apparatus, a configuration indicating whether to transmit the update information before the switching or after the switching.

In some example embodiments, the first apparatus further comprises: means for transmitting, to the second apparatus, an indication whether the update information is to be transmitted before the switching or after the switching.

In some example embodiments, the second switching period is indicated to the second apparatus in capability information of the first apparatus.

In some example embodiments, switching from a third frequency band to a fourth frequency band is further triggered for the first apparatus, and the first apparatus further comprises: means for determining the first switching period based on a switching period applied to the switching from the first frequency band to the second frequency band and a switching period applied to the switching from the third frequency band to the fourth frequency band.

In some example embodiments, switching from a third frequency band to a fourth frequency band is further triggered for the first apparatus, and the first apparatus further comprises: means for determining a third switching period during which the first apparatus switches from the third frequency band to the fourth frequency band; means for determining that the third switching period is different from a fourth switching period indicated to the second apparatus for the third and fourth frequency bands; and means for based on determining that the third switching period is different from the fourth switching period, transmitting, to the second apparatus, further update information associated with the third switching period.

In some example embodiments, the first apparatus comprises a terminal device, and the second apparatus comprises a network device.

In some example embodiments, the first apparatus further comprises means for performing other operations in some example embodiments of the method 600 or the first apparatus 110. In some example embodiments, the means comprises at least one processor; and at least one memory storing instructions that, when executed by the at least one processor, cause the performance of the first apparatus.

In some example embodiments, a second apparatus capable of performing any of the method 700 (for example, the second apparatus 120 in FIG. 1) may comprise means for performing the respective operations of the method 700. The means may be implemented in any suitable form. For example, the means may be implemented in a circuitry or software module. The second apparatus may be implemented as or included in the second apparatus 120 in FIG. 1.

In some example embodiments, the second apparatus comprises means for receiving, from a first apparatus, update information associated with a first switching period during which the first apparatus at least switches from a first frequency band to a second frequency band, wherein the first switching period is different from a second switching period indicated by the first apparatus for frequency band switching; and means for determining, based on at least the update information, a starting time for scheduling data transmission between the first apparatus and the second apparatus.

In some example embodiments, the second apparatus further comprises: means for transmitting, to the first apparatus at the starting time, scheduling information for the data transmission between the first apparatus and the second apparatus.

In some example embodiments, the update information is received within a time period after trigger of the switching from the first frequency band to the second frequency band.

In some example embodiments, the time period precedes a further starting time for the second apparatus to schedule the data transmission between the first apparatus and the second apparatus, and the further starting time is based on the second switching period.

In some example embodiments, the update information comprises at least one of: the first switching period, a difference between the first and second switching periods, or an indication of an end of the first switching period.

In some example embodiments, the second apparatus further comprises: means for receiving the update information from the first apparatus on a first carrier in the first frequency band before switching to the second frequency band, or means for receiving the update information from the first apparatus on a second carrier in the second frequency band after switching to the second frequency band.

In some example embodiments, the second apparatus further comprises: means for transmitting, to the first apparatus, a configuration indicating whether to transmit the update information before the switching or after the switching.

In some example embodiments, the second apparatus further comprises: means for receiving, from the first apparatus, an indication whether the update information is to be transmitted before the switching or after the switching.

In some example embodiments, the second switching period is indicated to the second apparatus in capability information of the first apparatus.

In some example embodiments, the second apparatus further comprises: means for receiving, from the first apparatus, further update information associated with a third switching period during which the first apparatus switches from a third frequency band to a fourth frequency band, wherein the third switching period is different from a fourth switching period indicated by the first apparatus for the third and fourth frequency bands; and means for determining the starting time based on the update information and the further update information.

In some example embodiments, the first apparatus comprises a terminal device, and the second apparatus comprises a network device.

In some example embodiments, the second apparatus further comprises means for performing other operations in some example embodiments of the method 700 or the second apparatus 120. In some example embodiments, the means comprises at least one processor; and at least one memory storing instructions that, when executed by the at least one processor, cause the performance of the second apparatus.

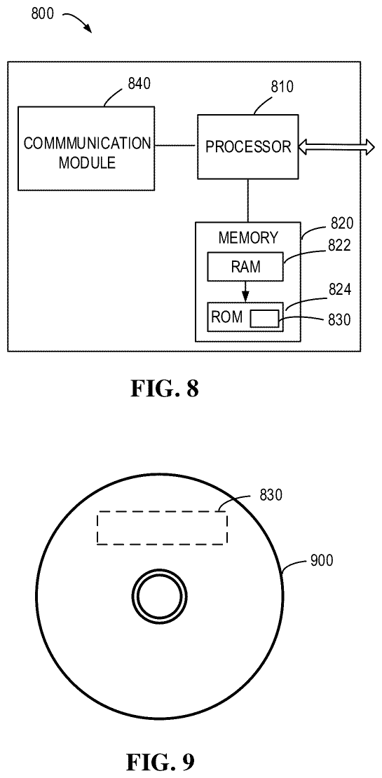

FIG. 8 is a simplified block diagram of a device 800 that is suitable for implementing example embodiments of the present disclosure. The device 800 may be provided to implement a communication device, for example, the first apparatus 110 or the second apparatus 120 as shown in FIG. 1. As shown, the device 800 includes one or more processors 810, one or more memories 820 coupled to the processor 810, and one or more communication modules 840 coupled to the processor 810.

The communication module 840 is for bidirectional communications. The communication module 840 has one or more communication interfaces to facilitate communication with one or more other modules or devices. The communication interfaces may represent any interface that is necessary for communication with other network elements. In some example embodiments, the communication module 840 may include at least one antenna.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The instructions of the program 830 may include instructions for performing operations/acts of some example embodiments of the present disclosure. The program 830 may be stored in the memory, e.g., the ROM 824. The processor 810 may perform any suitable actions and processing by loading the program 830 into the RAM 822.

The example embodiments of the present disclosure may be implemented by means of the program 830 so that the device 800 may perform any process of the disclosure as discussed with reference to FIG. 2 to FIG. 7. The example embodiments of the present disclosure may also be implemented by hardware or by a combination of software and hardware.

In some example embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 9 shows an example of the computer readable medium 900 which may be in form of CD, DVD or other optical storage disk. The computer readable medium 900 has the program 830 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first apparatus comprising:
at least one processor; and
at least one memory storing instructions that, when executed by the at least one processor, cause the first apparatus to:
determine a first switching period during which the first apparatus at least switches from a first frequency band to a second frequency band;
determine that the first switching period is different from a second switching period indicated to a second apparatus for frequency band switching; and
based on determining that the first switching period is different from the second switching period, transmit, to the second apparatus, update information associated with the first switching period.

2. The first apparatus of claim 1, wherein the instructions, when executed by the at least one processor, cause the first apparatus to:
receive, from the second apparatus at a starting time determined based on the update information, scheduling information for data transmission between the first apparatus and the second apparatus.

3. The first apparatus of claim 1, wherein the update information is transmitted within a time period after trigger of the switching from the first frequency band to the second frequency band.

4. The first apparatus of claim 3, wherein the time period precedes a further starting time for the second apparatus to schedule data transmission between the first apparatus and the second apparatus, and the further starting time is based on the second switching period.

5. The first apparatus of claim 1, wherein the update information comprises at least one of:
the first switching period,
a difference between the first and second switching periods, or
an indication of an end of the first switching period.

6. The first apparatus of claim 1, wherein the instructions, when executed by the at least one processor, cause the first apparatus to:
transmit the update information to the second apparatus on a first carrier in the first frequency band before switching to the second frequency band, or
transmit the update information to the second apparatus on a second carrier in the second frequency band after switching to the second frequency band.

7. The first apparatus of claim 6, wherein the instructions, when executed by the at least one processor, cause the first apparatus to:
receive, from the second apparatus, a configuration indicating whether to transmit the update information before the switching or after the switching.

8. The first apparatus of claim 6, wherein the instructions, when executed by the at least one processor, cause the first apparatus to:
transmit, to the second apparatus, an indication whether the update information is to be transmitted before the switching or after the switching.

9. The first apparatus of claim 1, wherein the second switching period is indicated to the second apparatus in capability information of the first apparatus.

10. The first apparatus of claim 1, wherein switching from a third frequency band to a fourth frequency band is further triggered, and the instructions, when executed by the at least one processor, cause the first apparatus to:
determine the first switching period based on a switching period applied to the switching from the first frequency band to the second frequency band and a switching period applied to the switching from the third frequency band to the fourth frequency band.

11. The first apparatus of claim 1, wherein switching from a third frequency band to a fourth frequency band is further triggered, and the instructions, when executed by the at least one processor, cause the first apparatus to:
determine a third switching period during which the first apparatus switches from the third frequency band to the fourth frequency band;
determine that the third switching period is different from a fourth switching period indicated to the second apparatus for the third and fourth frequency bands; and
based on determining that the third switching period is different from the fourth switching period, transmit, to the second apparatus, further update information associated with the third switching period.

12. The first apparatus of claim 1, wherein the first apparatus comprises a terminal device, and the second apparatus comprises a network device.

13. A second apparatus comprising:
at least one processor; and
at least one memory storing instructions that, when executed by the at least one processor, cause the second apparatus to:
receive, from a first apparatus, update information associated with a first switching period during which the first apparatus at least switches from a first frequency band to a second frequency band, wherein the first switching period is different from a second switching period indicated by the first apparatus for frequency band switching; and
determine, based on at least the update information, a starting time for scheduling data transmission between the first apparatus and the second apparatus.

14. The second apparatus of claim 13, wherein the instructions, when executed by the at least one processor, cause the second apparatus to:
transmit, to the first apparatus at the starting time, scheduling information for the data transmission between the first apparatus and the second apparatus.

15. The second apparatus of claim 13, wherein the update information is received within a time period after trigger of the switching from the first frequency band to the second frequency band.

16. The second apparatus of claim 15, wherein the time period precedes a further starting time for the second apparatus to schedule the data transmission between the first apparatus and the second apparatus, and the further starting time is based on the second switching period.

17. The second apparatus of claim 13, wherein the update information comprises at least one of:
the first switching period,
a difference between the first and second switching periods, or
an indication of an end of the first switching period.

18. The second apparatus of claim 13, wherein the instructions, when executed by the at least one processor, cause the second apparatus to:
receive the update information from the first apparatus on a first carrier in the first frequency band before switching to the second frequency band, or
receive the update information from the first apparatus on a second carrier in the second frequency band after switching to the second frequency band.

19. The second apparatus of claim 18, wherein the instructions, when executed by the at least one processor, cause the second apparatus to:
transmit, to the first apparatus, a configuration indicating whether to transmit the update information before the switching or after the switching.

20. The second apparatus of claim 18, wherein the instructions, when executed by the at least one processor, cause the second apparatus to:
receive, from the first apparatus, an indication whether the update information is to be transmitted before the switching or after the switching.
